(19) United States
(12) Patent Application Publication
(10) Pub. No.: US 2001/0021303 A1
(43) Pub. Date: Sep. 13, 2001

(54) Video encoding and decoding

(76) Inventors: Wilhelmus Hendrikus Alfonsus Bruls, Eindhoven (NL); Eduard Willem Salomons, Dublin (IE)

Correspondence Address: Corporate Patent Counsel, U.S. Philips Corporation, 580 White Plains Road, Tarrytown, NY, 10591, US

(21) Appl. No.: 09/773,156

(22) Filed: Jan. 31, 2001

(30) Foreign Application Priority Data
Feb. 1, 2000 (EP) 00200331.7

(51) Int. Cl. H04N 9/79

(52) U.S. Cl. 386/34

(57) ABSTRACT

A video encoder is usually designed to have a given performance at a given resolution. For example, MPEG2 encoders are known that compress video at ‘601’ resolution (720×576 pixels) into IPPP sequences using 2 MB of RAM. The invention provides the feature of selectably (82a, 82b) encoding images in a lower resolution mode. The spare capacity of resources in the low-resolution mode (e.g. memory capacity and memory bandwidth) is used to improve the performance (e.g. higher image quality, lower bit rate). More particularly, the RAM (81) and motion estimator (9) required for producing P-pictures in the high-resolution mode are arranged (83, 84) to produce B-pictures in the low-resolution mode.

### FIELD OF THE INVENTION

The invention relates to a video encoder and a method of encoding images in a first resolution mode with reference to a reference image having said first resolution. The invention also relates to a corresponding video decoder and a method of decoding such images.

### BACKGROUND OF THE INVENTION

Predictive video encoders and decoders as defined in the opening paragraph are generally known in the field of video compression. For example, the MPEG video compression standard specifies P-pictures as images which are encoded with reference to a previous image of the sequence. The previous image may be an I-picture, i.e. an image being autonomously encoded without reference to other images of the sequence, or another P-picture. The previous image is stored in a memory.

The MPEG standard also specifies B-pictures as images which are encoded with reference to a previous image as well as a subsequent image. B-pictures are encoded more efficiently than P-pictures. However, the encoding of B-pictures requires the encoder to have twice the memory capacity and substantially twice the memory bandwidth. Similar considerations apply to the corresponding decoder.

Designing an MPEG encoder is thus a matter of balancing circuitry complexity and memory capacity (i.e. chip area) versus compression efficiency. In view thereof, the company of Philips introduced an integrated circuit on the market, which allows I- and P-coding only. The circuit produces IPPP sequences of images having a resolution of 720×576 pixels, usually referred to as ‘601’ or ‘D1’ resolution.

### OBJECT AND SUMMARY OF THE INVENTION

It is an object of the invention to provide a more flexible video encoder and decoder.

To this end, the video encoder in accordance with the invention is characterized in that the video encoder comprises control means for selectably encoding said images in a second, lower resolution mode with reference to two reference images having said second resolution, and for storing said two reference images with the second resolution in said memory. It is thereby achieved that the same video encoder can produce B-pictures in a lower resolution mode with the same resources, in particular memory. The lower resolution is preferably half of the first resolution mode, e.g. 352×576 pixels, usually referred to as ‘½D1’ resolution.

Video encoders usually include a motion estimation circuit, which applies a predetermined search strategy in the first resolution mode to search motion vectors representing motion between an input image and the reference image. In an embodiment of the invention, said motion estimation circuit applies said search strategy in the second resolution mode to both reference images. This embodiment is based on the recognition that the time which is available for searching motion vectors in the first resolution mode allows twice searching such motion vectors in the lower resolution mode (at the same frame rate). In an MPEG encoder, in which B-pictures refer to a previous image as well as a subsequent image, the motion estimation circuit is thus used to search both the forward and backward motion vectors in the lower resolution mode.

A further embodiment of the video encoder is based on the recognition that the double amount of time is available for encoding P-pictures (i.e. pictures encoded with reference to a single reference frame) compared with encoding of B-pictures. In accordance therewith, the motion estimation circuit is arranged to apply the search strategy in a first pass to search motion vectors with a first precision, and to apply said search strategy in a second pass to refine the precision of the motion vectors found in the first pass. It is thereby achieved that the motion vectors associated with P-pictures are more precise than the motion vectors associated with B-pictures. This is particularly attractive because P-pictures are generally wider apart from each other than B-pictures.

### BRIEF DESCRIPTION OF THE FIGURES

FIG. 1 shows a schematic diagram of a video encoder in accordance with the invention.

FIGS. 2 and 3 show diagrams to illustrate the operation of the video encoder.

FIGS. 4A-4C show images to illustrate a two-pass motion vector search process carried out by a motion estimation and compensation circuit, which is shown in FIG. 1.

### DESCRIPTION OF EMBODIMENTS

The invention will now be described with reference to an MPEG encoder for producing IPPP sequences in D1 resolution and IBBP sequences in ½D1 resolution. That is, the encoder produces I and P-pictures in the D1 resolution mode, and I, B and P-pictures in the ½D1 resolution mode. However, the invention is not restricted to video encoders or decoders complying with the MPEG standard. The essential aspect is that images are predictively encoded with reference to one reference image in one resolution mode and predictively encoded with reference to two reference images in a lower resolution mode.

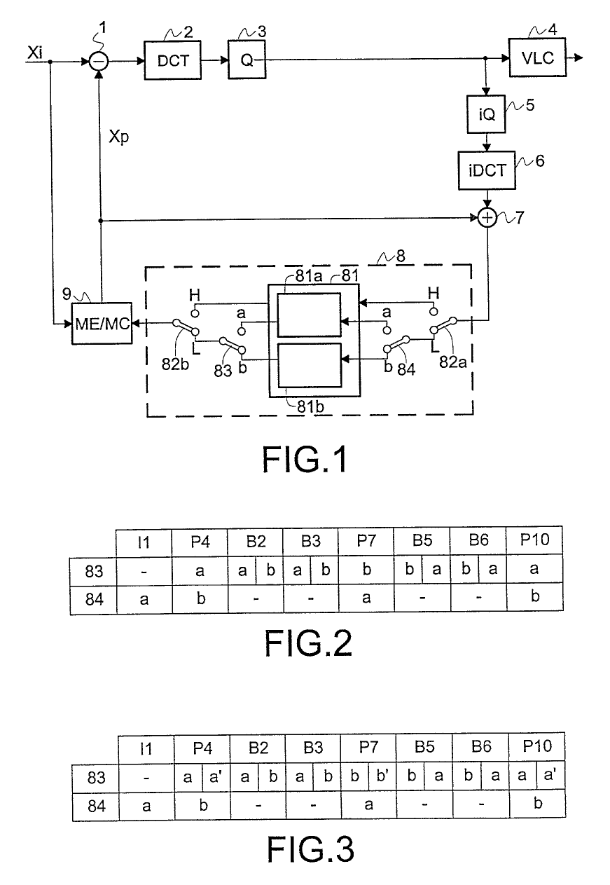

FIG. 1 shows a schematic diagram of an MPEG video encoder in accordance with the invention. The general layout is known per se in the art. The encoder comprises a subtracter 1, an orthogonal transform (e.g. DCT) circuit 2, a quantizer 3, a variable-length encoder 4, an inverse quantizer 5, an inverse transform circuit 6, an adder 7, a memory unit 8, and a motion estimation and compensation circuit 9.

The memory unit 8 includes a memory 81 having a capacity for storing a reference image having a high resolution of, for example, 720×576 pixels (usually referred to as D1). The same memory can store two reference images having substantially half said resolution, i.e. 360×576 pixels (usually referred to as ½D1). This is symbolically shown in the Figure by two memory parts having reference numerals 81a and 81b. The memory unit further includes user-operable switches 82a and 82b for selectably switching the encoder into the high-resolution encoding mode or the low-resolution mode.

In the high-resolution encoding mode, images having D1-resolution are written into and read from memory 81 with the switches 82a and 82b in the position denoted H. Because only one image at this resolution can be stored at a time, the MPEG encoder can only produce I-pictures or P-pictures. As is generally known in the art of video coding, I-pictures are autonomously encoded images without reference to a previously encoded image. The subtracter 1 is inactive. The I-pictures are locally decoded and stored in memory 81. P-pictures are predictively encoded with reference to a previous I or P-picture. The subtracter 1 is active. The subtracter 1 subtracts a motion-compensated prediction image Xₚ from the input image Xᵢ, so that the difference is encoded and transmitted. The adder 7 adds the locally decoded image to the prediction image so as to update the stored reference image.

In the low-resolution mode, images having ½D1-resolution are written into and read from memories 81a and 81b with the switches 82a and 82b in the position denoted L. In this encoding mode, two further switches 83 and 84 are operated. Switch 83 controls which one of the memories is read by the motion estimator, switch 84 controls in which one of the memories the locally decoded image is stored. Note that the switches in memory unit 8 are implemented as software-controlled memory-addressing operations in practical embodiments of the encoder.

In the low-resolution mode, the encoder operates as follows. I-pictures are again encoded with subtracter 1 being inoperative. The locally decoded I-picture is written into memory 81a (switch 84 in position a). The first P-picture is predictively encoded with reference to the stored I-picture (switch 83 in position a), and its locally decoded version is written into memory 81b (switch 84 in position b). Subsequent P-pictures are alternately read from and written into the memories 81a and 81b, so that memory 8 keeps the last two I or P-pictures at any time. This allows bi-directional predictive coding of images (B-pictures) in the low-resolution mode.

B-pictures are encoded with reference to a previous and a subsequent I or P-picture. Note that this requires the encoding order of images to be different from the display order. Circuitry therefor is known in the art and not shown in the Figure. The motion estimation and compensation circuit 9 now accesses both memories 81a and 81b to generate forward motion vectors (referring to the previous image) and backward motion vectors (referring to the subsequent image). To this end, the switch 83 switches between position a and position b. Adder 7 is inoperative during B-encoding.

FIG. 2 shows a timing diagram to summarize the operation of the encoder. The diagram shows the positions of switches 83 and 84 during consecutive frame periods for encoding an IBBPBBP sequence. The frames are identified by encoding type (I, B, P) and display order. I1 is the first frame, B2 is the second frame, B3 is the third frame, P4 is the fifth frame, etc. Switching between the two memories in the B-encoding mode is shown on a frame-by-frame basis for simplicity. In practice, the switching is done at the macroblock level.

The motion estimation circuit executes a given motion vector search process. Said process requires reading of the respective memory for a given number of times, say N, in the low-resolution mode. The same process requires 2N memory accesses per frame in the high-resolution mode. As FIG. 2 clarifies, encoding of B-pictures requires 2N memory accesses per frame period in the low-resolution mode. Accordingly, the memory bandwidth requirements are substantially the same in the high-resolution mode and the low-resolution mode. The feature of B-encoding in the low-resolution mode thus does not require additional hardware or software resources. This is a significant advantage of the invention.

FIG. 2 further reveals that the vector search process requires N memory accesses per frame in the P-encoding mode, whereas 2N accesses are available. This recognition is exploited in a further aspect of the invention. To this end, the motion vector search process is carried out in two passes for P-pictures. In the first pass, the motion vectors are found with a ‘standard’ precision. In the second pass, the search process is continued to further refine the accuracy of the motion vectors that were found in the first pass. The two-pass operation is illustrated in FIG. 3, the refining pass being denoted by a′ or b′, as the case may be. Note again that the two-pass operation is carried out in practice on a macroblock-by-macroblock basis.

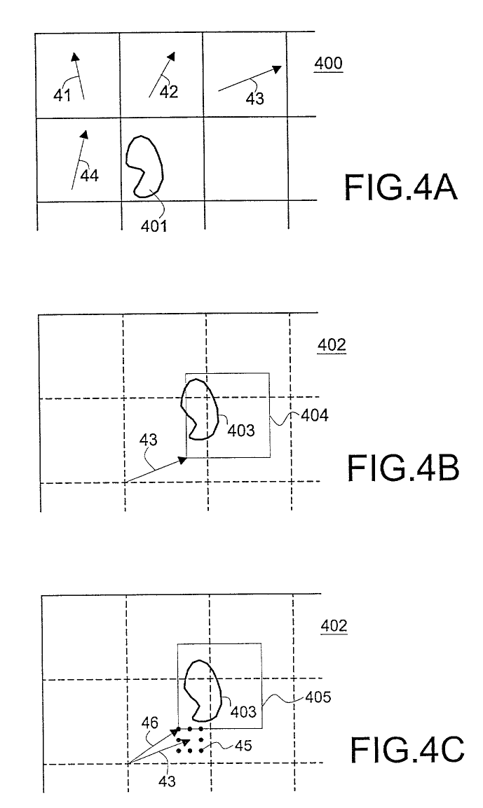

FIGS. 4A-4C show parts of an image to further illustrate the two-pass motion estimation process. FIG. 4A shows a current image 400 to be predictively encoded. The image is divided into macroblocks. A current macroblock to be encoded includes an object 401. Reference numerals 41, 42, 43 and 44 denote motion vectors already found during encoding of the neighboring macroblocks. FIGS. 4B and 4C show the previous I or P-picture 402 stored in one of the memories 81a or 81b, as the case may be. In the previous reference image, the object (now denoted 403) is at a different position and has a slightly different shape. In this example, the motion estimator searches the best motion vector from among a number of candidate motion vectors. Various strategies for selecting suitable candidate motion vectors are known in the art. It is here assumed that the motion vectors denoted 41, 42, 43 and 44 in FIG. 4A are among the candidate motion vectors for the current macroblock. FIG. 4B shows the result of the first motion vector search process pass. It appears that candidate motion vector 43 provides the best match between the current macroblock of the input image and an equally sized block 404 of the reference image.

In the second pass, the motion vector search is applied with different candidate vectors. More particularly, the motion vector found in the first pass is one candidate motion vector. Other candidate vectors are further refinements thereof. This is illustrated in FIG. 4C, where 43 is the motion vector found in the first pass and eight dots 45 represent end points of new candidate motion vectors. They differ from motion vector 43 by one (or one-half) pixel. The search algorithm is now carried out with the new candidate vectors. It appears in this example that block 405 best resembles the current macroblock. Accordingly, motion vector 46 is the motion vector, which is used for producing the motion-compensated prediction image Xₚ. The two-pass operation for P-pictures is particularly attractive because it provides more accurate motion vectors for images that are wider apart than B-pictures.

It is to be noted that the two-pass motion vector search can also be applied to B-pictures in a yet lower resolution mode (SIF, 352×288 pixels). The inventive idea of using available memory and motion estimation circuitry for enhancing the image quality or reducing the bit rate at lower resolutions can also be applied to other resources of the video encoder. For example, the ‘overcapacity’ of transform circuits 2,6, quantizers 3,5 and variable-length encoder 4 in FIG. 1 allows two-pass encoding in which the first pass is used as a step of analyzing image complexity, and the second pass is used for actual coding.

It is further noted that the invention is also applicable in multi-resolution video decoders. Since a decoder corresponds to the local decoding loop of the encoder as described above, a separate description thereof is not necessary.

The invention can be summarized as follows. A video encoder is usually designed to have a given performance at a given resolution. For example, MPEG2 encoders are known that compress video at ‘601’ resolution (720×576 pixels) into IPPP sequences using 2 MB of RAM. The invention provides the feature of selectably (82a, 82b) encoding images in a lower resolution mode. The spare capacity of resources in the low-resolution mode (e.g. memory capacity and memory bandwidth) is used to improve the performance (e.g. higher image quality, lower bit rate). More particularly, the RAM (81) and motion estimator (9) required for producing P-pictures in the high-resolution mode are arranged (83, 84) to produce B-pictures in the low-resolution mode.

1. A video encoder for encoding images in a first resolution mode with reference to a reference image having said first resolution, the encoder comprising a memory having the capacity for storing said reference image with said first resolution, characterized in that the video encoder comprises control means for selectably encoding said images in a second, lower resolution mode with reference to two reference images having said second resolution, and for storing said two reference images with the second resolution in said memory.

2. A video encoder as claimed in claim 1, further including a motion estimation circuit applying a predetermined search strategy in the first resolution mode to search motion vectors representing motion between an input image and the reference image, said motion estimation circuit being arranged to apply said search strategy in the second resolution mode to both reference images.

3. A video encoder as claimed in claim 2, wherein selected images are encoded in the second resolution mode with respect to one of said reference images, the motion estimation circuit being arranged to apply the search strategy in a first pass to search motion vectors with a first precision, and to apply said search strategy in a second pass to refine the precision of the motion vectors found in the first pass.

4. A video encoder as claimed in claim 2, further arranged to selectably encode images in a third, yet lower resolution mode with reference to two reference images having said third resolution, said motion estimation circuit being arranged to apply said search strategy in the third resolution mode to both reference images, and to apply the search strategy for each reference image in a first pass to search motion vectors with a first precision, and to apply said search strategy in a second pass to refine the precision of the motion vectors found in the first pass.

5. A video encoder as claimed in any one of claims 1 to 4, wherein said reference image having the first resolution is a previous image of a sequence of images, one of the reference images having the second resolution is a previous image of said sequence, and the other one of the reference images having the second resolution is a subsequent image of said sequence.

6. A method of encoding images in a first resolution mode with reference to a reference image having said first resolution, comprising the step of storing said reference image with said first resolution in a memory having the capacity therefor, characterized in that the method comprises the steps of selectably encoding said images in a second, lower resolution mode with reference to two reference images having said second resolution, and storing said two reference images with the second resolution in said memory.

7. A method as claimed in claim 6, further including a step of searching motion vectors representing motion between an input image and the reference image in the first resolution mode, said searching being applied to both reference images in the second resolution mode.

8. A method as claimed in claim 7, wherein selected images are encoded in the second resolution mode with respect to one of said reference images, the searching step being applied in a first pass to search motion vectors with a first precision, and in a second pass to refine the precision of the motion vectors found in the first pass.

9. A method as claimed in claim 7, further arranged to selectably encode images in a third, yet lower resolution mode with reference to two reference images having said third resolution, said searching step being applied in the third resolution mode to both reference images, and in a first pass to search motion vectors with a first precision, and in a second pass to refine the precision of the motion vectors found in the first pass.

10. A method as claimed in any one of claims 6 to 9, wherein said reference image having the first resolution is a previous image of a sequence of images, one of the reference images having the second resolution is a previous image of said sequence, and the other one of the reference images having the second resolution is a subsequent image of said sequence.

11. A video decoder for decoding images in a first resolution mode with reference to a reference image having said first resolution, the decoder comprising a memory having the capacity for storing said reference image with said first resolution, characterized in that the video decoder comprises control means for decoding said images in a second, lower resolution mode with reference to two reference images having said second resolution, and for storing said two reference images with the second resolution in said memory.

12. A method of decoding images in a first resolution mode with reference to a reference image having said first resolution, comprising the step of storing said reference image with said first resolution in a memory having the capacity therefor, characterized in that the method comprises the steps of decoding said images in a second, lower resolution mode with reference to two reference images having said second resolution, and storing said two reference images with the second resolution in said memory.
